(19) United States
(12) Patent Application Publication
(10) Pub. No.: US 2025/0172028 A1
(43) Pub. Date: May 29, 2025

(54) TENSION ARRANGEMENT FOR A DOOR OPERATOR SYSTE

(71) Applicant: Assa Abloy Entrance Systems AB, Landskrona (SE)

(72) Inventors: Daniel ELIASSON, Lund (SE); Ivan RAJIC, Lund (SE); Anders LOFGREN, Kavlikge (SE); Anton HANSSON, Yngsio (SE); Johanns SJOBERG, Malmo (SE); Linus BACKLUND, Forslov (SE)

(21) Appl. No.: 18/840,160

(22) PCT Filed: Mar. 1, 2023
(86) PCT No.: PCT/EP2023/055162

§ 371 Date: Aug. 21, 2024

(30) Foreign Application Priority Data
Mar. 1, 2022 (SE) 2230058-6

(51) Int. Cl. E05F 15/67; E05F 15/684

(52) U.S. Cl. CPC E05F 15/67; E05F 15/684; E05Y 2201/672; E05Y 2201/724; E05Y 2900/106

(57) ABSTRACT

ASSA ABLOY Entrance Systems AB has developed the present invention relates to a connection device (100) for a door operator system(S) for opening and closing an opening (O). Said door operator system(S) comprises a door (20) and a drive unit mounted on said door (20) and arranged to move the door (20) between an open and closed position. The door operator system comprises an elongated transmission member (40) extending along a side of the opening (O), wherein a driven transmission member (34) of said drive unit (30) is arranged to interplay with said first elongated transmission member (40) so as to move the door (20) between the closed and open position. Said tension arrangement (100) comprises a bracket member (110) for facilitating attachment of said tension arrangement (100); a tension device (T) comprising a connection member (120) for connecting said first elongated transmission member (40) and a spring arrangement (130) comprising a spring member (132). Said spring arrangement (130) is configured to be connected to said connection member (120) so as to facilitate adapting the spring load of said spring member (132). Said tension device (T) is configured to be arranged in connection to said bracket member (110) so that tension of said first elongated transmission member (40) is facilitated. The present invention also relates to a door operator system.

### TECHNICAL FIELD

The present invention relates to a tension arrangement for a door operator system. The present invention relates to a door operator system comprising such a tension arrangement.

### BACKGROUND

A door operator system for a door typically comprises a door connected to a door frame and a drive unit arranged to move the door along the door frame between an open and closed position for opening and closing the opening. The door, which may be a sectional door, is typically used as a garage door or as an industrial door. The drive unit can further comprise a motor to move the door.

In conventional overhead sectional doors an electric motor mounted above the door pulls up the door using wires attached to the door. Such an overhead sectional door often implements balancing springs to reduce the force required to open the door, which increases complexity and is cumbersome to install. Should there be a damage such as a broken wire on such a conventional overhead sectional door, mechanical devices are used to stop the door from falling.

To achieve a more efficient door operator system that reduces the complexity and the risks of the door operator system during operation, maintenance and installation, a door operator system with drive units mounted to the door has been developed.

In order to obtain high accuracy and proper aligning in connection to operation of the door, elongated transmission members, e.g. chains, along the sides of the door opening may be implemented. In such a system, driven sprockets on the door may interface with elongated transmission members extending next to the door. Such elongated transmission members extending next to the door need to have a certain tension in order to provide proper operation of the door operator system.

There is thus a need for a tension arrangement for a door operator system which facilitates providing tension of such elongated transmission members in an easy and efficient way for proper operation of the door operator system.

### Objects of the Invention

An object of the present invention is to provide a tension arrangement for a door operator system comprising elongated transmission member for movement of a door of the door operator system, which facilitates providing tension of said elongated transmission member in an easy and efficient way for proper operation of the door operator system.

Another object of the present invention is to provide a door operator system comprising such a tension arrangement.

### SUMMARY

These and other objects, apparent from the following description, are achieved by tension arrangement for a door operator system and a door operator system comprising such a tension arrangement. Preferred embodiments of the tension arrangement and door operator system are defined in appended dependent claims.

Specifically an object of the invention is achieved by a tension arrangement for a door operator system. The door operator system is configured for opening and closing an opening. The door operator system comprises: a door frame comprising a first frame section at a first side of the opening and a second frame section at a second side of the opening opposite the first side; a door arranged to be moved between an open position and a closed position, the door being movably arranged in connection to the door frame. The door operator system further comprises a drive arrangement, said drive arrangement comprising a drive unit mounted on the door, said drive unit comprising at least one motor being arranged to move the door between the open position and closed position and a first driven transmission member in driving connection with the motor. The door operator system further comprises a first elongated transmission member extending along the first side of the opening between an upper position and a lower position, the first elongated transmission member being configured to be connected at said upper position and at said lower position. The first driven transmission member is movably connected to said first elongated transmission member and arranged to interplay with said first elongated transmission member for driving the first driven transmission member along said first elongated transmission member by means of the first elongated transmission member so as to move the door between the closed and open position. Said tension arrangement is configured to be attached in connection to said first side at one of said upper and lower positions. Said tension arrangement comprises a bracket member for facilitating attachment of said tension arrangement. Said tension arrangement further comprises a tension device comprising a connection member for connecting said first elongated transmission member and a spring arrangement comprising a spring member. Said spring arrangement is configured to be connected to said connection member so as to facilitate adapting the spring load of said spring member, wherein said spring tension device is configured to be arranged in connection to said bracket member so that, when said first elongated transmission member is connected at one of said upper and lower positions and connected to said connection member at the other of said upper and lower positions, tension of said first elongated transmission member is provided.

Hereby desired tension of the elongated transmission member, e.g. chain, may be provided in an easy and efficient way. By thus facilitating adaption of the spring load of the spring member, desired tension for elongated transmission member, e.g. chain, of different length may be efficiently handled. Wider tolerances is hereby facilitated. Further, easy and efficient assembly, e.g. assembly not requiring any tools, is facilitated by providing a tension arrangement with such a bracket member and tension device thus connectable. The tension device is arranged to be connected to said bracket member so that the maximum load associated with the elongated transmission member is taken by the bracket member.

According to an embodiment of the tension arrangement, said spring arrangement comprises a connection element arranged in connection to said spring member so as to facilitate said adaption of the spring load of said spring member, wherein said bracket member comprises at least one groove configured to receive said connection element so as to support said spring tension device. Hereby adaption of the spring load of said spring member is facilitated. Herby lifting force associated with the elongated transmission member is absorbed by the bracket member. The connection element of said spring arrangement of said tension device is arranged to be connected to said at least one groove of said bracket member so that the maximum load associated with the elongated transmission member is taken by the bracket member, i.e. the at least one groove of the bracket member.

According to an embodiment of the tension arrangement, said bracket member comprises a set of grooves at different levels, wherein said connection element is movably arranged relative to said connection member so as to facilitate introducing said connection element into a groove at a level providing a desired tension of said first elongated transmission member. Hereby desired tension of the elongated transmission member, e.g. chain, may be obtained in an easy and efficient way.

According to an embodiment of the tension arrangement, said connection member comprises a receiving portion and a connection portion, wherein said receiving portion is configured to receive said connection element and spring member, said spring arrangement further comprising a lock member, said connection portion being configured to provide a stop for said connection element, wherein said spring member is arranged at said spring arrangement receiving portion between said connection element and said lock member, said connection element being movably arranged in connection to said receiving portion so as to facilitate said adaption of the spring load of said spring member. Hereby adaption of said spring load of said spring member may be obtained in an easy and efficient way.

According to an embodiment of the tension arrangement, said receiving portion has an end portion and an adaption portion arranged between said end portion and said connection portion. Hereby said spring member may be easily and efficiently applied to said receiving portion and spring load of said spring member may be obtained in an easy and efficient way. Assembly of said spring member to said receiving portion may be obtained without requiring any tools.

According to an embodiment of the tension arrangement, said end portion has a through hole for receiving said lock member. Hereby assembly and locking of said spring member may be obtained in an easy and efficient way. Assembly of said lock member at said end portion of said receiving portion may be obtained without requiring any tools.

According to an embodiment of the tension arrangement, said connection element has a through opening, wherein said opening and said receiving portion are arranged so that said connection element can be movably brought around said receiving portion and be stopped by said connection portion and so that said connection element, at said adaption portion, is rotatable between a first position, allowing movement of said connection element along said receiving portion for connection and disconnection, and a second position, allowing movement only along said adaption portion between said connection portion providing a first stop and said end portion providing a second stop. Hereby easy and efficient assembly of said spring arrangement is facilitated. Hereby easy and efficient assembly of said spring arrangement not requiring any tools is facilitated. Hereby securing of said spring member to said connection member is easily and efficiently facilitated.

According to an embodiment of the tension arrangement, said connection member comprises a first connection member with a first connection portion and a second connection member with a second connection portion, the respective connection portion comprising one or more teeth, said one or more teeth of the respective connection portion being configured to face said one or more teeth of the other connection portion and engage with an end portion of said first elongated transmission member for providing said connection. Hereby easy, efficient and secure connection of said elongated transmission member, e.g. chain, is facilitated.

According to an embodiment of the tension arrangement, said at least one groove comprises retention means for retaining said connection element in said groove. Hereby the connection element may be efficiently retained at said bracket member.

According to an embodiment of the tension arrangement, said bracket member has an elongated configuration configured to extend along a portion of said first side, when said tension arrangement is attached in connection to said first side, having a first end portion, an opposite second end portion and an intermediate portion, wherein said at least one groove is arranged at said intermediate portion.

According to an embodiment the tension arrangement further comprises a guiding roller configured to be arranged in connection to an end portion of said bracket member so that its axis extends transversal to the longitudinal extension of the bracket member, said first elongated transmission member, when said tension arrangement is attached in connection to said first side and the first elongated transmission member is connected to the connection member, is configured to run from said connection member towards said end portion and turn, wherein said guiding roller is configured to guide said first elongated transmission member so that it turns around in connection to said guiding roller, extending in the opposite direction along said first side to the other connection position. Hereby efficient guiding of said elongated transmission member and efficient arrangement of the tension arrangement in connection to said first side is facilitated.

According to an embodiment of the tension arrangement, said connection member has an elongated configuration configured to extend along the longitudinal extension of said bracket member. Hereby efficient support by means of said bracket member may be efficiently provided.

According to an embodiment of the tension arrangement, said bracket member has a U-shaped configuration comprising a bottom portion configured to constitute the attachment side, and a first side portion and opposite second side portion essentially parallel to said first side portion, said side portions extending in the longitudinal direction of said bracket member. Hereby efficient support by means of said bracket member may be efficiently provided.

According to an embodiment of the tension arrangement, said at least one groove is provided as one or more recesses in the respective side portion of said bracket member. Hereby efficient support by means of said bracket member may be efficiently provided.

According to an embodiment of the tension arrangement, said tension arrangement is configured to be attached in connection to said first side at said lower position. Hereby easy and efficient assembly is facilitated. Hereby efficient tensioning of said elongated transmission member, e.g. chain, may be easily provided. Hereby easy and efficient operation of said door operator system is facilitated.

Specifically an object of the invention is achieved by a door operator system. The door operator system is configured for opening and closing an opening. The door operator system comprises: a door frame comprising a first frame section at a first side of the opening and a second frame section at a second side of the opening opposite the first side; a door arranged to be moved between an open position and a closed position, the door being movably arranged in connection to the door frame. The door operator system further comprises a drive arrangement, said drive arrangement comprising a drive unit mounted on the door, said drive unit comprising at least one motor being arranged to move the door between the open position and closed position and a first driven transmission member in driving connection with the motor. The door operator system further comprises a first elongated transmission member extending along the first side of the opening between an upper position and a lower position, the first elongated transmission member being configured to be connected at said upper position and at said lower position. The first driven transmission member is movably connected to said first elongated transmission member and arranged to interplay with said first elongated transmission member for driving the first driven transmission member along said first elongated transmission member by means of the first elongated transmission member so as to move the door between the closed and open position. Said door operator system comprises a tension arrangement a set out herein, for providing tension of said first elongated transmission member.

According to an embodiment of the door operator system, said drive arrangement comprises a second driven transmission member in driving connection with a motor of said drive arrangement. The door operator system comprises a second elongated transmission member extending along the second side of the opening between an upper position and a lower position, the second elongated transmission member being configured to be connected at said upper position and at said lower position, wherein the second driven transmission member is movably connected to said second elongated transmission member and arranged to interplay with said second elongated transmission member for driving the second driven transmission member along said second elongated transmission member by means of the second elongated transmission member so as to move the door between the closed and open position. Said door operator system comprises a tension arrangement as set out herein, for providing tension of said second elongated transmission member.

### BRIEF DESCRIPTION OF THE DRAWINGS

For a better understanding of the present disclosure reference is made to the following detailed description when read in conjunction with the accompanying drawings, wherein like reference characters refer to like parts throughout the several views, and in which:

FIG. 1 schematically illustrates a perspective view of a door operator system for opening and closing an opening, comprising a door in a closed position, according to an embodiment of the present disclosure;

FIG. 2 schematically illustrates a front view of a door operator system for opening and closing an opening, comprising a door in a closed position, according to an embodiment of the present disclosure;

FIG. 3 schematically illustrates a perspective view of a part of a door operator system with a drive unit and a tension arrangement for the door operator system according to an aspect of the present disclosure;

FIG. 4 schematically illustrates a perspective view of a tension arrangement for a door operator system according to an aspect of the present disclosure;

FIG. 5 schematically illustrates an exploded perspective view of the tension arrangement in FIG. 4, according to an aspect of the present disclosure;

FIG. 6a schematically illustrates a front view of the tension arrangement in FIG. 4, according to an aspect of the present disclosure;

FIG. 6b schematically illustrates a side view of the tension arrangement in FIG. 4, according to an aspect of the present disclosure;

FIG. 7 schematically illustrates a perspective view of the tension arrangement in FIG. 4 arranged in connection to a frame section of a door operator system, where an elongated transmission member is connected to the tension arrangement, according to an aspect of the present disclosure;

FIG. 8a schematically illustrates a perspective view of a connection member and a connection element of the tension arrangement in FIG. 4 in an assembly situation, according to an aspect of the present disclosure;

FIG. 8b schematically illustrates a perspective view of the connection member and connection element in FIG. 8a in an assembly situation associated with connection of an elongated transmission member, according to an aspect of the present disclosure;

FIG. 9a schematically illustrates a perspective view of the connection member and connection element in FIG. 8a in an assembly situation associated with a spring member of the tension arrangement in FIG. 4, according to an aspect of the present disclosure; and,

FIG. 9b schematically illustrates a perspective view of a spring arrangement comprising said connection element, spring member and a lock member of the tension arrangement, connected to said connection member, according to an aspect of the present disclosure.

### DETAILED DESCRIPTION

Embodiments of the invention will now be described with reference to the accompanying drawings. The invention may, however, be embodied in many different forms and should not be construed as limited to the embodiments and aspects set forth herein; rather, these embodiments and aspects are provided so that this disclosure will be thorough and complete, and will fully convey the scope of the invention to those skilled in the art. The terminology used in the detailed description of the particular embodiments/aspects illustrated in the accompanying drawings is not intended to be limiting of the invention. In the drawings, like numbers refer to like elements.

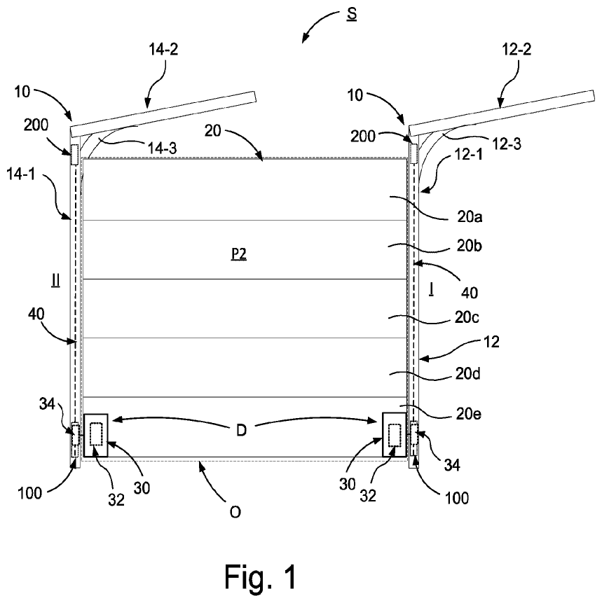

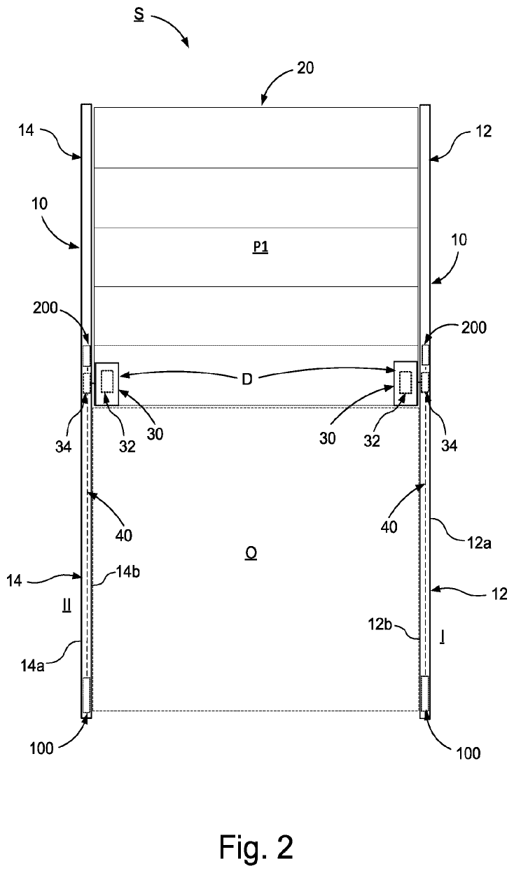

FIG. 1 schematically illustrates a perspective view and FIG. 2 a front view of a door operator system S in which the inventive aspects of the present invention may be applied. The door operator system comprises a door frame 10, a drive arrangement D and a door 20. The door operator system S is arranged to be installed in an opening O defined by a wall and a floor/ground. The door 20 is connected to the door frame 10. The door operator system S is arranged to open and close the opening O by moving the door 20 between an open position P1 and a closed position P2. The door 20 is in the closed position P2 in FIG. 1 and in the open position P1 in FIG. 2. The open position may be a horizontal open position, which the door operator system in FIG. 1 schematically illustrates, in the form of a planar horizontal position or an inclined horizontal position such as a vertical open position as illustrated in FIG. 2. The closed position P2 may be a vertical closed position P2.

In the embodiment illustrated in e.g. FIG. 1, the door 20 is a sectional door 20 comprising a plurality of horizontal and interconnected sections 20a-e connected to the door frame 10. In one embodiment, the door is a garage door. In an alternative embodiment, the door is an industrial door. The door 20 is arranged to be moved along the door frame 10 between the closed position P2 and the open position P1.

The door operator system S may comprise a first terminal and a second terminal, not shown. The at least one terminal is configured to transmit energy for charging an energy storage device, such as a battery, for powering the motor of the drive unit. In an alternative embodiment, power may be supplied to motor of the drive unit by means electric wiring.

The door operator system schematically illustrated in FIG. 1 is an up and over door operator system. An up and over door operator system is a system in which the door in the closed position P2 is arranged substantially vertical and in the open position P1 is arranged substantially horizontal and inside of the opening.

In an alternative embodiment, the door operator system may be a door operator system in which the door in the closed position P2 is arranged substantially vertical and in the open position P1 is arranged in an inclined position disposed between a substantially vertical and a substantially horizontal position. For example, the door may be arranged at a 45° angle from a horizontal position P1 in the open position P1, as the skilled person recognizes however the door may be arranged at any angle disposed between the horizontal and vertical orientation of the door in the open position P1.

The door frame 10 comprises a first frame section 12 at a first side I of the opening O and a second frame section 14 at a second side Il of the opening O. The door frame 10 is connected to the wall and to the floor, i.e. the floor of the opening O. In one embodiment, the first frame section 12 comprises a substantially vertically extending part 12-1 and a substantially horizontally extending part 12-2. The second frame section 14 comprises a substantially vertically extending part 14-1 and a substantially horizontally extending part 14-2. The vertically extending part 12-1, 14-1 and the horizontally extending part 12-2, 14-2 are connected to create a path for the door 20 to glide on and a track for the drive unit 30 to interact with.

Thus, each of the first frame section 12 and the second frame section 14 comprising a vertically extending part 12-1, 14-1, a horizontally extending part 12-2, 14-2 and a bent interconnecting part 12-3, 14-3. Worded differently, The first frame section 12 comprises a vertically extending part 12-1, a horizontally extending part 12-2 and a bent interconnecting part 12-3. The bent interconnecting part 12-3 thus connects the vertically extending part 12-1 and the horizontally extending part 12-2. Similarly, the second frame section 14 comprises a vertically extending part 14-1, a horizontally extending part 14-2 and a bent interconnecting part 14-3. The bent interconnecting part 14-3 thus connects the vertically extending part 14-1 and the horizontally extending part 14-2.

The vertically extending parts 12-1, 14-1 may be vertical parts 12-1, 14-1 or inclined vertical parts 12-1, 14-1. Similarly, the horizontally extending parts 12-2, 14-2 may horizontal parts 12-2, 14-2 or inclined horizontal parts 12-2, 14-2.

The door 20 is at a first side moveably connected to the first frame section 12 and at a second side moveably connected to the second frame section 14. In one embodiment, one or more of the plurality of sections 20a-e is connected to the first frame section 12 at said first side I and to the second frame section 14 at said second side II.

The door operator system S comprises said drive arrangement D for operation of said door operator system. Said drive arrangement D comprises a drive unit 30 mounted on the door 20. Said drive unit 30 comprises at least one motor 32. Said at least one motor 32 is arranged to move the door 20 between the closed position P2 and open position P1.

To allow for the driving of the door 20, the door operator system S further comprises an elongated transmission member 40 extending along the first side I of the opening O. The elongated transmission member 40 may further extend along the first frame section 12. The drive unit 30 further comprises a driven transmission member 34 which is in driving connection with the motor 32.

The driven transmission member 34 is movably connected to the elongated transmission member 40 and arranged to interplay with said elongated transmission member 40 for driving the driven transmission member 34 along said elongated transmission member 40 by means of the elongated transmission member 40 at least partially wrapping around the driven transmission member 34. Thus, the elongated transmission member 40 is arranged to at least partially envelope said driven transmission member 34.

The elongated transmission member 40 does in comparison with a fixed rack provide a more cost-efficient solution both in terms of manufacturing and installation. Furthermore, the elongated transmission member allows for relative movement between the door 20 and the frame and does not require a high accuracy and proper aligning in the same manner as a fixed rack solution. The elongated transmission member may thus be arranged to allow for a degree of movement along a direction orthogonal to the first frame section 12.

Further, the elongated transmission member 40 enables a safer door operator system due to said elongated transmission member following and keeping the engagement with the driven transmission member, at least to some extent, even if the door is pushed away from the rail. In addition, the elongated transmission member is more silent and resistant to wear compared to a fix rack and less likely to malfunction due to pinching of external objects.

The elongated transmission member 40 may be in the form of a bendable transmission member. The elongated transmission member 40 may be in the form of a suspended transmission member. It is noted that bendable in this context does not necessarily imply that said transmission member necessarily is flexible but only that it allows for wrapping around the driven transmission member. Accordingly, the transmission member 40 may be considered to be arranged to be in engagement with the driven transmission member 34 and provide for relative movement between the driven transmission member 34 and a direction of movement of the door 20 as defined by the frame 10. Worded differently said transmission member may be considered as a non-fix transmission member or a suspended transmission member. The elongated transmission member may accordingly be arranged to engage the driven transmission member independently of the frame.

The drive unit 30 is moveably connected to the elongated transmission member 40. Accordingly, drive unit 30 is connected to said elongated transmission member 40 so as to allow for relative movement between the door and the frame, whereby the drive unit 30 is fixed to the door 20. The drive unit 30 comprises at least one motor 32. The drive unit 30 is arranged to move the door 20 from the closed position to the open position. To provide power to the motor 32, the at least one motor 32 may be connected to at least one energy storage device, such as a battery, arranged to power the at least one motor 32.

In one embodiment, the drive unit 30 is arranged to move the door from the open position P1 to the closed position P2. In one embodiment, the door 20 is arranged to move from the open position P1 to the closed position P2 by means of the weight of the door 20. In one embodiment, the drive unit 30 is arranged to brake the door 20 when moving from the open position P1 to the closed position P2.

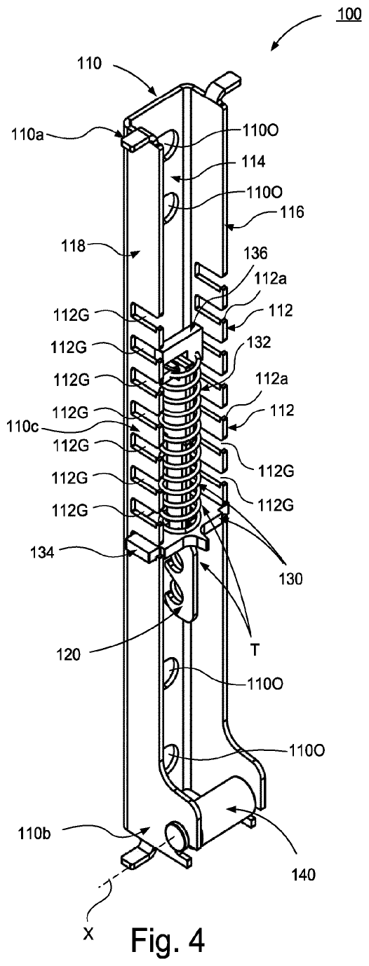

The door operator system S comprises a tension arrangement 100 for facilitating tensioning of said elongated transmission member. Said tension arrangement is, in the embodiments shown in FIGS. 1 and 2, arranged at a lower position in connection to said elongated transmission member 40. According to an aspect of the present disclosure, the elongated transmission member 40 is configured to be connected at an upper position and to said tension arrangement 100 at said lower position. Said tension arrangement is described in more detail below with reference to e.g. FIGS. 4, 5, 6a-b and 7.

By arranging said tension arrangement 100 at said lower position, easier access for an operator performing service work involving tensioning of the elongated transmission member is facilitated.

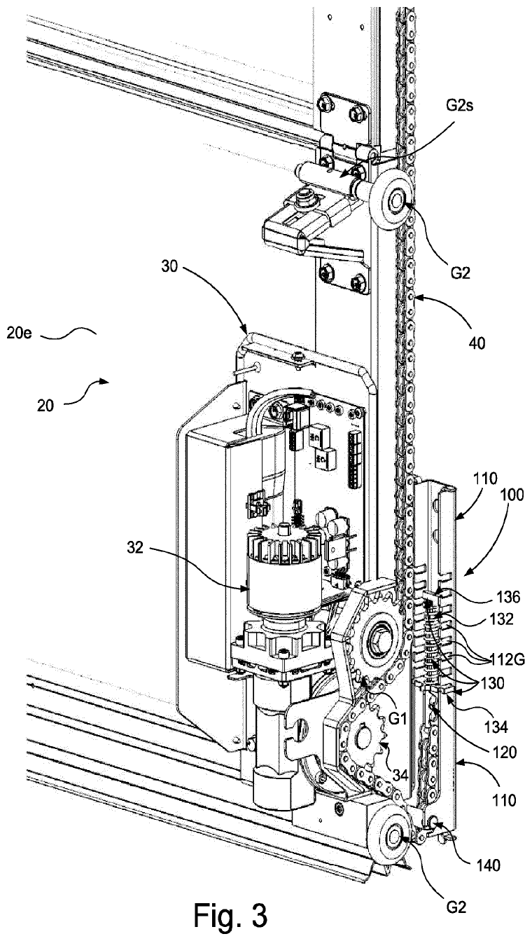

FIG. 3 schematically illustrates a perspective view of a part of a door operator system with a drive unit 30 and a tension arrangement for the door operator system according to an aspect of the present disclosure.

In one embodiment, as illustrated in FIG. 3, the door operator system further comprises at least one guide member G1. The at least one guide member G1 is mounted to the door 20. The guide member G1 may be arranged to interplay with the elongated transmission member 40 for guiding the door 20 along the elongated transmission member 40 by means of the elongated transmission member 40 at least partially wrapping around the at least one guide member G1. The guide member G1 thus moves the elongated transmission member 40 and guides the driven transmission member 34 in relation to said elongated transmission member 40 to properly align them. The guide member G1 may preferably be a rotatable guide member which may be mounted to the door 20 by means of a journaled connection. Thus, the elongated transmission member 40 may be arranged to at least partially envelope said guide member G1.

With reference to FIG. 3, the elongated transmission member 40 may be arranged to wrap around and interplay with a portion of the driven transmission member 34 and a portion of the guide member G1. The portion of the driven transmission member 34 interplaying with the elongated transmission member 40 being opposite to the portion of the guide member G1 interplaying with said elongated transmission member 40. This achieves a larger interface between the driven transmission member, guide member and elongated transmission member, whereby a more stable door operator system which requires less torque to operate may be achieved.

As shown in e.g. FIG. 3, the elongated transmission member 40 is connected to the tension arrangement 100 and arranged the first side I of the opening O.

The elongated transmission member 40 may be any conventional elongated transmission member 40 providing the required slack to compensate for horizontal or diagonal movement of the drive unit and/or door. The elongated transmission member may be a belt or a chain.

In one embodiment, the elongated transmission member 40 may be a belt. Thus, the guide member G1 and the driven transmission member 34 may be pulley elements arranged to interface with said belt. In one embodiment, the belt may be a cogged belt or a ribbed belt, whereby the guide member G1 and the driven transmission member 34 may be cogged wheels interfacing with the ribs of said cogged or ribbed belt.

The elongated transmission member 40 may also be a chain, which is depicted in e.g. FIG. 3. The chain may be provided with slots for receiving cogs. Accordingly, the driven transmission member 34 may be a cogged wheel arranged to interplay with the chain, e.g. the slots of the chain. The driven transmission member 34 may be a sprocket. Further, the guide member G1 may be a cogged wheel arranged to interplay with the chain, e.g. the slots of the chain. The guide member G1 may be a sprocket. In one embodiment, the guide member G1 may be a ribbed wheel for interplaying with the chain. In one embodiment, the chain is a non-endless chain, e.g. a single chain only partially enveloping the guide member(s) and the driven transmission member(s).

In one embodiment, the door operator system further comprises a first set of guide rollers G2 and a second set of guide rollers G2. Said first and second set of guide rollers are mounted to the door 20. The first set of guide rollers G2 are arranged to interplay with the first frame section 12 and the second set of guide rollers G2 are arranged to interplay with the second frame section 14. The guide rollers thus moves together with the door 20 in a guided manner along the trajectory formed by the frame, e.g. the first frame section 12 and the second frame section 14.

In one embodiment, the drive unit 30 is mounted to the bottommost section 20e of the door 20.

The guide roller G2 is according to an aspect mounted to the door 20 by means of a shaft G2s.

According to an aspect of the present disclosure, as schematically illustrated in FIGS. 1 and 2, the door operator system comprises a pair of elongated transmission members 40 to allow for a more stable movement pattern of the door 20. A first elongated transmission member 40 extends along the first side I of the opening O. The first elongated transmission member 40 may further extend along the first frame section 12. A second elongated transmission member 40 extends along the second side II of the opening O. The second elongated transmission member 40 may further extend along the second frame section 14. The guiding and driving arrangements discussed with reference to the first side of the door 20 may accordingly be mirrored to the second side of the door 20.

Thus, the door operator system S may further comprise a first and second driven transmission member 34 arranged to interplay with the first and second elongated member 40 by means of the first and second elongated transmission member at least partially wrapping around the first and second driven transmission member, respectively.

The first and second driven transmission member 34 may be driven by means of a single or multiple motors 32. In one embodiment, a single motor 32 is in driving connection with the first and second transmission member 34. The single motor 32 may be connected to the first and second driven transmission members 34 by means of a first and second shaft extending from the motor 32. As will be further described with reference to FIG. 3, the drive unit 30 may comprise a first and a second motor each being in driving connection with the first and second driven transmission member 34, respectively.

Analogously to the first vertical side of the door, the second side of the door may have one or more guide members mounted thereon. In one embodiment, the door operator system further comprises at least one guide member G1 mounted to the door 20 arranged to interplay with the second elongated transmission member 40 for guiding the door 20 along the second elongated transmission member 40 by means of the second elongated transmission member 40 at least partially wrapping around said guide member. Worded differently, said door operator system comprises at least one first guide member G1 mounted on the door 20 arranged to interplay with the first elongated transmission member 40 and at least one second guide member G1 mounted on the door 20 arranged to interplay with the second elongated transmission member 40 by means of the first and second elongated transmission member 40 at least partially wrapping around the first and second guide member, respectively.

Both the elongated transmission members 40 may be connected to a respective tension arrangement 100 as schematically illustrated in FIGS. 1 and 2. A top end of the elongated transmission members 40 may be fixedly mounted and a bottom end of said elongated transmission members 40 may be connected to the tension arrangement 100 according to the present disclosure. This allows for easier access for an operator performing service work involving tensioning by means of said tension arrangement 100.

The first and second driven transmission member 34 may be arranged to extend from the door 20 in opposite directions towards the first and second elongated transmission member 40, respectively. The first driven transmission member 34 may be arranged proximal to a first vertical phase of the door, said first phase being adjacent to the first elongated transmission member when the door is in the closed position. Similarly, the second driven transmission member 34 may be arranged proximal to a second vertical phase of the door, said second phase being adjacent to the second elongated transmission member when the door is in the closed position.

In one embodiment wherein the drive unit 30 comprises a single motor, the motor may be connected to a reduction gearing which may be in the form of a gearbox, whereby an output shaft of the gearbox is connected to the first and second driven transmission member 34 so as to transfer torque to said first and second driven transmission member 34, or in the case of the operator system only having one elongated transmission member, the single driven transmission member.

In one embodiment wherein the drive unit 30 comprises the first and second motor 32. The first motor may be connected to a first reduction gearing, such as a gearbox, in turn connected to the first driven transmission member. The second motor may be connected to a second reduction gearing, such as a gearbox, in turn connected to the second driven transmission member.

The motors 32 and the drive unit 30 are preferably arranged on the same main phase of the door 20, e.g. an outer or inner phase of the door 20. To protect the motors 32 and drive unit 10, said motors and drive unit are arranged on an inner phase of the door in the form of an interior facing door phase of the door 20.

In one embodiment, the motor(s) 32 of the drive unit 30 is a direct current DC motor 32. In a preferred embodiment, the motor(s) 32 is a brushless direct current (BLDC) motor(s).

In FIG. 3, where the door 20 is in the closed position P2 and drive unit is arranged on a lower section 20e of the door 20, a tension arrangement 100 according to an aspect of the present disclosure is attached in connection to said first side I at a lower position. The elongated transmission member 40, here in the shape of a chain/chain configuration, is at an end portion 42 connected to the tension arrangement 100, and at an upper position in connection to said first side I to e.g. any suitable connection device, not shown connected at an opposite end portion, not shown.

The tension arrangement 100 is also illustrated in FIGS. 4, 5, 6a-b and 7 and will be described in more detail below.

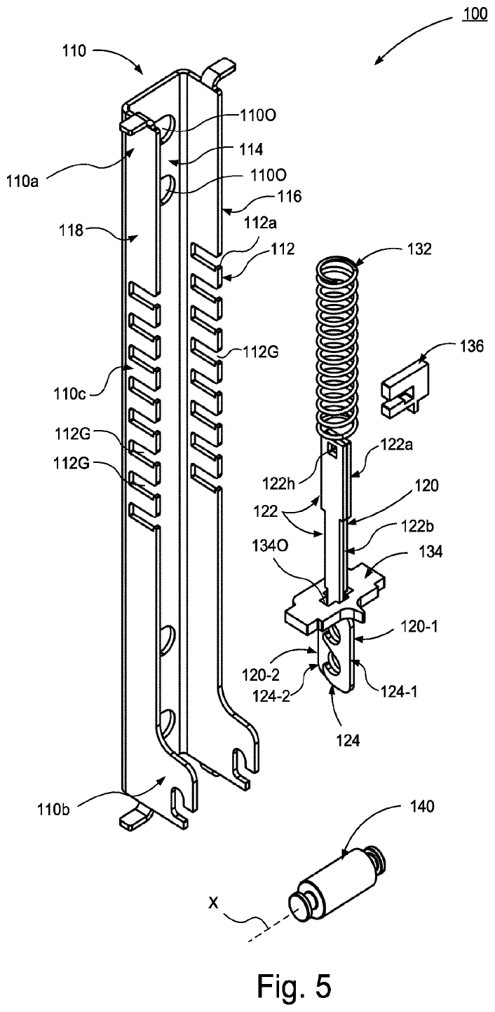

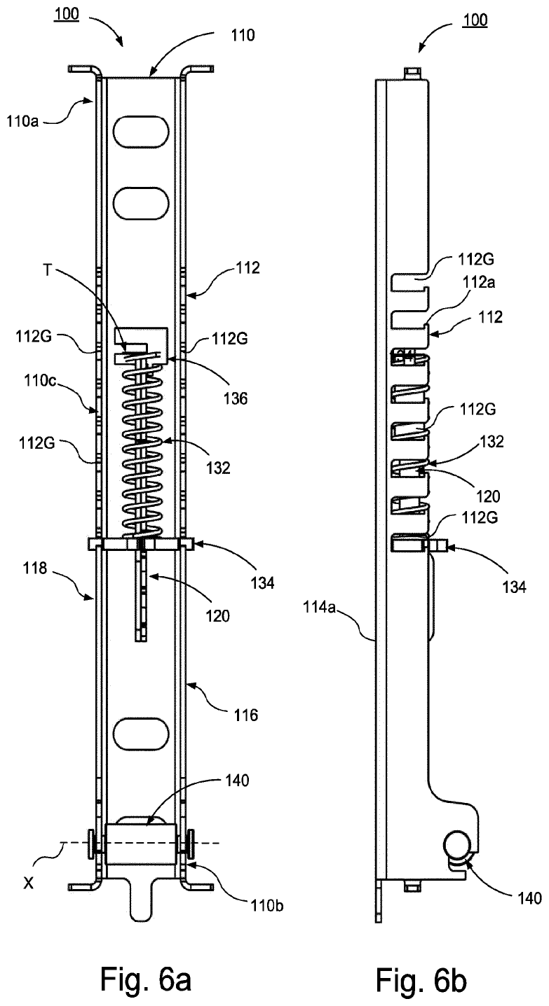

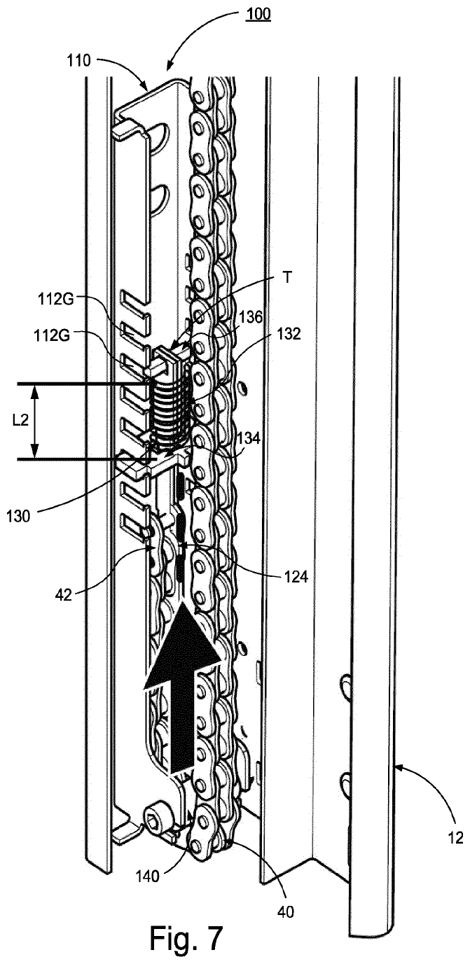

FIG. 4 schematically illustrates a perspective view, FIG. 5 an exploded perspective view, FIG. 6a a front view, FIG. 6b a side view, and FIG. 7 another perspective view of a tension arrangement for a door operator system according to an aspect of the present disclosure.

The tension arrangement 100 comprises a bracket member 110 for facilitating attachment of said tension arrangement 100.

According to an aspect of the present disclosure, said bracket member 110 has an elongated configuration configured to extend along a portion of said first side I, when said tension arrangement 100 is attached in connection to said first side I.

According to an aspect of the present disclosure, said bracket member 110 has a first end portion 110a, an opposite second end portion 110b and an intermediate portion 110c. In the embodiment with the tension arrangement 100 arranged at said lower position, as illustrated e.g. in FIG. 3, the first end portion 110a is the upper end portion and the second end portion 110b is the lower end portion, with the intermediate portion 110c arranged there between.

According to an aspect of the present disclosure, said bracket member 110 has a U-shaped configuration comprising a bottom portion 114 configured to constitute the attachment side, and a first side portion 116 and opposite second side portion 118 essentially parallel to said first side portion 116, said side portions extending in the longitudinal direction of said bracket member 110. The bottom portion has an outer side 114a configured to be the attachment side and thus configured to face towards the surface to which said bracket member 110 is attached.

According to an aspect of the present disclosure, said bracket member 110 comprises through openings 110O arranged through said bottom portion 114 for facilitating attachment of said bracket member, e.g. by means of a joint member J1 as illustrated in FIG. 7.

Said bracket member 110 comprises at least one groove 112G. According to an aspect of the present disclosure, as illustrated in e.g. FIGS. 4, 5, 6a-b and 7, said bracket member 110 comprises a set of grooves 112G arranged at said intermediate portion 110c.

According to an aspect of the present disclosure, as illustrated in e.g. FIGS. 4, 5, 6a-b and 7, said set of grooves 112G are provided as recesses in the respective side portion 116, 118 of said bracket member 110. Said set of grooves 112G in the respective side portion 116, 118 are provided such that a groove 112G in the first side portion 116 and a groove 112G transversally opposite in the second side portion 112G forms a pair of grooves 112G arranged at the same level when said bracket member 110 is attached in connection to a side of the door opening at a frame section.

Said pair of grooves 112G of the set of grooves 112G formed as recesses in the respective side portion 116, 118 of said bracket member 110 provides different levels of said bracket member 110 for receiving a connection element 134 of said tension device T. Said connection element 134 is described in more detail below.

Said set of grooves 112G formed as recesses in the respective side portion 116, 118 of said bracket member 110 forms a set of protrusions 112 in said intermediate portion 110c of said bracket member. Thus, the respective side portion 116, 118 of said bracket member 110 comprises a set of protrusions 112 in said intermediate portion 110c of said bracket member. Said protrusions 112 are configured to protrude essentially orthogonal to the longitudinal and transversal extension of said bracket member 110, distributed along the respective side portion 116, 118, said grooves 112G being provided between adjacent protrusions 112 along the respective side portion 116, 118 of said bracket member 110.

According to an aspect of the present disclosure, said at least one groove 112G comprises retention means 112a for retaining said connection element 134 in said groove 112G. According to an aspect of the present disclosure, said retention means 112a are provided by stop portions in connection to the outer end of the respective groove 112G, i.e. the end of the groove 112G furthers away from the bottom portion 114 of the bracket member 110.

According to an aspect of the present disclosure, said retention means 112a are provided by stop end portions of the respective protrusion 112 arranged so that said connection element 134 is allowed to be introduced into a pair of grooves 112G at a desired level and so that, when said connection element 134 is introduced into said pair of grooves 112G, said connection element 134 is prevented from sliding out by means of said retention means 112a shaped as stop end portions at said protrusions 112 in connection to the outer end of said grooves 112G.

The tension arrangement 100 comprises a tension device T. Said tension device T, when said tension arrangement 100 is attached and utilized for tensioning of said elongated transmission member 40, is configured to be connected to the bracket member 110. Said tension device T, when said tension arrangement 100 is attached and utilized for tensioning of said elongated transmission member 40, is configured to be connected to the bracket member 110 by means of said connection element 34.

Said tension device T comprises a connection member 120 for connecting said first elongated transmission member 40. Said tension device T further comprises a spring arrangement 130.

Said spring arrangement 130 comprises a spring member 132. Said spring arrangement 130 is configured to be connected to said connection member 120 so as to facilitate adapting the spring load of said spring member 132.

Said tension device T is configured to be arranged in connection to said bracket member 110 so that, when said bracket member is attached at said lower position and said first elongated transmission member 40 is connected to said connection member 120, as shown e.g. in FIG. 3 and FIG. 7, tension of said first elongated transmission member 40 is provided.

Said spring arrangement 130 comprises said connection element 134. Said connection element 134 is according to an aspect a plate shaped element. Said connection element 134 is according to an aspect shaped so that it fits in said grooves 112G of said bracket member. Said connection element 134 is according to an aspect shaped so that pair of grooves 112G at different levels of said intermediate portion 110c of said bracket member 110 can receive said connection element 134.

Said connection element 134 is configured to be arranged in connection to said spring member 132 so as to facilitate said adaption of the spring load of said spring member 132. Said set of grooves 112G are configured to receive said connection element 134 so as to provide connection of said tension device T. According to an aspect of the present disclosure, said set of grooves 112G are configured to receive said connection element 134 so as to support said tension device T.

According to an aspect of the present disclosure, said connection element 134 is configured to be movably arranged relative to said connection member 120 so as to facilitate introducing said connection element 134 into a groove 112G/pair of grooves 112G at a level providing a desired tension of said first elongated transmission member 40.

According to an aspect of the present disclosure, said connection member 120 has an elongated configuration configured to extend along the longitudinal extension of said bracket member 110 when said tension device T is connected to said bracket member 110.

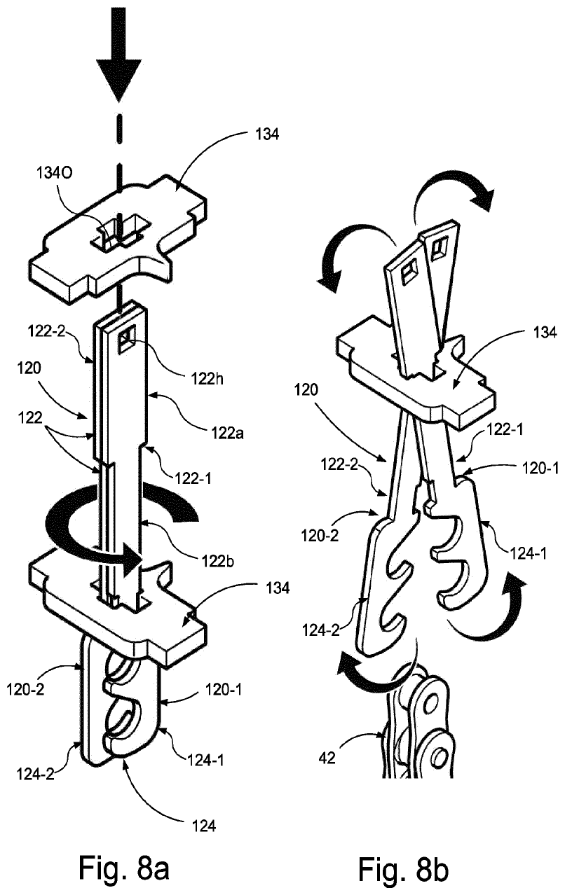

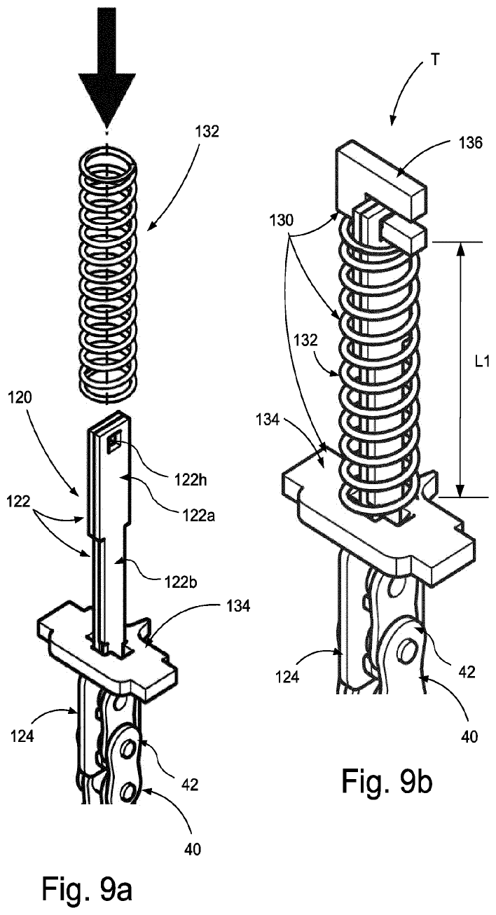

FIGS. 8a-b and 9a-b schematically illustrates perspective views of parts of the tension device T of the tension arrangement 100, comprising the connection member 120 and connection element 134 in assembly situations and also said spring arrangement 130 connected to said connection member 120, as illustrated in FIG. 9b.

According to an aspect of the present disclosure, said connection member 120 comprises a receiving portion 122 and a connection portion 124. Said receiving portion 122 is configured to receive said connection element 134 and spring member 132. Said connection portion 124 is configured to provide connection an end portion 42 of said elongated transmission member 40, e.g. chain.

According to an aspect of the present disclosure, said spring arrangement 130 further comprises a lock member 136 configured to lock said spring member at said receiving portion 122, between said connection element and said connection element 134.

According to an aspect of the present disclosure, said connection portion 124 is configured to provide a stop for said connection element 134, wherein said spring member 132 is arranged at said spring arrangement receiving portion 122 between said connection element 134 and said lock member 136.

Said connection portion 124 has a wider transversal extension compared to said receiving portion 122 so that said connection element 134 is allowed to move along said receiving portion 122 but is stopped by means of the wider transversal extension of said connection portion 124. Thus, the transition of the elongated connection member 120 from said receiving portion 122 to said connection portion 124 is configured to provide a stop for said connection element 134.

Said connection element 134 is configured to be movably arranged in connection to said receiving portion 122 so as to facilitate said adaption of the spring load of said spring member 132. Said connection element 134 has a through opening 134O, see e.g. FIG. 8a, so as to facilitate applying said connection element 134 onto and around said receiving portion 122 of said connection member 120.

According to an aspect of the present disclosure, said receiving portion 122 has an end portion 122a and an adaption portion 122b arranged between said end portion 122a and said connection portion 124. According to an aspect of the present disclosure, said end portion 122b has a through hole 122h for receiving said lock member 136.

According to an aspect of the present disclosure, said through opening 134O of said connection element 134 and said receiving portion 122 are arranged so that said connection element 134 can be movably brought around said receiving portion 122 and be stopped by said connection portion 124.

According to an aspect of the present disclosure, said through opening 134O of said connection element 134 and said receiving portion 122 are arranged so that said connection element 134, at said adaption portion 122b, is rotatable between a first position, allowing movement of said connection element 134 along the entire receiving portion 122 for connection to and disconnection from said connection member, and a second position, allowing movement only along said adaption portion 122b between said connection portion 124 providing a first stop and said end portion 122a providing a second stop, see e.g. FIG. 8a.

According to an aspect of the present disclosure, said receiving portion 122 has an elongated configuration, where said end portion 122a has a wider transversal extension relative to the longitudinal extension than the adaption portion 122b. According to an aspect of the present disclosure, said through opening 134O of said connection element 134 has a cross shaped configuration with a wider opening portion configured to fit around said end portion 122a and said adaption portion 122b, and a shorter opening portion configured to fit only around said adaption portion. According to an aspect of the present disclosure, said shorter opening portion of said through opening 134O is configured to run essentially transversal to said wider opening portion of said through opening 134O.

According to an aspect of the present disclosure, said connection member 120 comprises a first connection member 120-1 with a first connection portion 124-1 and a second connection member 120-2 with a second connection portion 124-2. The connection portion 124-1, 124-2 of the respective connection member 120-1, 120-2 comprises one or more teeth. Said one or more teeth of the respective connection portion are configured to face said one or more teeth of the other connection portion and engage with an end portion 42 of an elongated transmission member 40 for providing said connection, see e.g. 8b.

According to an aspect of the present disclosure, said first connection member 120-1 with said first connection portion 124-1 and said second connection member 120-2 with said second connection portion 124-2 are, in connection to connecting said end portion 42 of said elongated transmission member 40, e.g. chain, configured to be moved relative to each other in a controlled way by means of moving the connection element 134, being in the second position, towards said end portion 122a so that the first and second connection portions are moved away from each other with said one or more teeth facing each other so as to allow introduction of said end portion of said elongated transmission member 40 there between, and then move said connection element towards the connection portions so that they engage with said end portion 42 for connection of said elongated transmission member 40.

When said end portion 42 is connected to said connection portion 124 of said connection member 120, said spring member 132 is configured to be applied to said receiving portion 122 of said connection member 120, see FIG. 9a. Said spring member 132 is according to an embodiment a coil spring member 132.

When said spring member 132 has been applied to said receiving portion 122 of said connection member 120, said lock member 136 is configured to be applied at said end portion 122a so that said spring member 132 is arranged between said connection element 134 and said lock member 136. Hereby said tension device T has been assembled. The thus describe assembling of said tension device may be obtained without using any tools. The spring load of said spring member 132 may hereby be adapted by moving said connection element 134 along said adaption portion 122b.

The tension device T is then configured to be connected to said bracket member 110 by introducing said connection element 134 into a groove 112G/pair of grooves 112G at a desired level of said set of grooves 112G/pair of grooves 112G, see e.g. FIGS. 3 and 7.

The spring load of said spring member 132, when locked between said connection element 134 and said lock member 136, may be adapted between a first spring load corresponding to a first position of the connection element 134 closest to the connection portion 124, which corresponds to a first length L1 of said spring member 132, see FIG. 9b, and a second spring load corresponding to a second position of said connection element 134 at a second position closer to said end portion 122a, which corresponds to a second length L2 of said spring member 132, see FIG. 7, and spring loads there between.

According to an aspect of the present disclosure, said first spring load corresponds to the spring load when said spring member 132 is locked between said connection element 134 and said lock member 136 but no pressure/force is applied on said connection element 134. According to an aspect of the present disclosure, said second spring load corresponds to the maximum spring load when said spring member 132 is locked between said connection element 134 and said lock member 136 and pressure/force is applied on said connection element 134.

According to an aspect of the present disclosure, said tension arrangement 100 further comprises a guiding roller 140 configured to be arranged in connection said second end portion 110b of said bracket member 110, see e.g. FIGS. 5 and 6a. The guiding roller 140 is configured to be arranged in connection to said bracket member 110 so that the axis X of the guiding roller 140 extends transversal to the longitudinal extension of the bracket member 110.

According to an aspect of the present disclosure, an elongated transmission member 40, e.g. chain, when said tension arrangement 100 is attached at said lower position in connection to a side of a door operator system and the first elongated transmission member 40 is connected to the connection member 120, is configured to run from said connection member towards said second end portion 110b and turn so that said elongated transmission member 40 continues upwardly along said side of said door operator system, in connection to a frame section, to an upper position where it is connected.

Said guiding roller 140 is configured to guide said elongated transmission member 40 so that it turns around in connection to said guiding roller 140, extends in the opposite direction along said side of the door operator system to the upper connection position.

The description of the aspects of the disclosure provided herein has been presented for purposes of illustration. The description is not intended to be exhaustive or to limit aspects of the disclosure to the precise form disclosed, and modifications and variations are possible in light of the above teachings or may be acquired from practice of various alternatives to the provided aspects of the disclosure. The examples discussed herein were chosen and described in order to explain the principles and the nature of various aspects of the disclosure and its practical application to enable one skilled in the art to utilize the aspects of the disclosure in various manners and with various modifications as are suited to the particular use contemplated. The features of the aspects of the disclosure described herein may be combined in all possible combinations of methods, apparatus, modules, systems, and computer program products. It should be appreciated that the aspects of the disclosure presented herein may be practiced in any combination with each other.

It should be noted that the word “comprising” does not necessarily exclude the presence of other elements or steps than those listed. It should further be noted that any reference signs do not limit the scope of the claims.

1. A tension arrangement (100) for a door operator system (S), the door operator system(S) being configured for opening and closing an opening (O), the door operator system comprising:
a door frame (10) comprising a first frame section (12) at a first side (I) of the opening (O) and a second frame section (14) at a second side (II) of the opening (O) opposite the first side (I);
a door (20) arranged to be moved between an open position and a closed position, the door (20) being movably arranged in connection to the door frame (10);
a drive arrangement (D), said drive arrangement comprising a drive unit (30) mounted on the door (20), said drive unit (30) comprising at least one motor (32) being arranged to move the door (20) between the open position and closed position and a first driven transmission member (34) in driving connection with the motor (32), the door operator system comprising
a first elongated transmission member (40) extending along the first side (I) of the opening (O) between an upper position and a lower position, the first elongated transmission member (40) being configured to be connected at said upper position and at said lower position, wherein the first driven transmission member (34) is movably connected to said first elongated transmission member (40) and arranged to interplay with said first elongated transmission member (40) for driving the first driven transmission member (34) along said first elongated transmission member (40) by means of the first elongated transmission member (40) so as to move the door (20) between the closed and open position,
wherein said tension arrangement (100) is configured to be attached in connection to said first side (I) at one of said upper and lower positions, said tension arrangement (100) comprising
a bracket member (110) for facilitating attachment of said tension arrangement (100);
a tension device (T) comprising a connection member (120) for connecting said first elongated transmission member (40) and a spring arrangement (130) comprising
a spring member (132), said spring arrangement (130) being configured to be connected to said connection member (120) so as to facilitate adapting the spring load of said spring member (132),
wherein said tension device (T) is configured to be arranged in connection to said bracket member (110) so that, when said first elongated transmission member (40) is connected at one of said upper and lower positions and connected to said connection member (120) at the other of said upper and lower positions, tension of said first elongated transmission member (40) is provided.

2. The tension arrangement (100) according to claim 1, wherein said spring arrangement (130) comprises a connection element (134) arranged in connection to said spring member (132) so as to facilitate said adaption of the spring load of said spring member (132), wherein said bracket member (110) comprises at least one groove (112G) configured to receive said connection element (134) so as to support said tension device (T).

3. The tension arrangement (100) according to claim 2, wherein said bracket member (110) comprises a set of grooves (112G) at different levels, wherein said connection element (134) is movably arranged relative to said connection member (120) so as to facilitate introducing said connection element (134) into a groove (112G) at a level providing a desired tension of said first elongated transmission member (40).

4. The tension arrangement (100) according to claim 2, wherein said connection member (120) comprises a receiving portion (122) and a connection portion (124), wherein said receiving portion (122) is configured to receive said connection element (134) and spring member (132), said spring arrangement (130) further comprising a lock member (136), said connection portion (124) being configured to provide a stop for said connection element (134), wherein said spring member (132) is arranged at said spring arrangement receiving portion (122) between said connection element (134) and said lock member (136), said connection element (134) being movably arranged in connection to said receiving portion (122) so as to facilitate said adaption of the spring load of said spring member (132).

5. The tension arrangement (100) according to claim 4, wherein said receiving portion (122) has an end portion (122a) and an adaption portion (122b) arranged between said end portion (122a) and said connection portion (124).

6. The tension arrangement (100) according to claim 5, wherein said end portion (122b) has a through hole (122h) for receiving said lock member (136).

7. The tension arrangement (100) according to claim 5, wherein said connection element (134) has a through opening (134O), wherein said opening (134O) and said receiving portion (122) are arranged so that said connection element (134) can be movably brought around said receiving portion (122) and be stopped by said connection portion (124) and so that said connection element (134), at said adaption portion (122b), is rotatable between a first position, allowing movement of said connection element (134) along said receiving portion for connection and disconnection, and a second position, allowing movement only along said adaption portion (122b) between said connection portion (124) providing a first stop and said end portion (122a) providing a second stop.

8. The tension arrangement (100) according to claim 4, wherein said connection member (120) comprises a first connection member (120-1) with a first connection portion (124-1) and a second connection member (120-2) with a second connection portion (124-2), the respective connection portion comprising one or more teeth, said one or more teeth of the respective connection portion being configured to face said one or more teeth of the other connection portion and engage with an end portion of said first elongated transmission member for providing said connection.

9. The tension arrangement (100) according to claim 8, wherein said at least one groove (112G) comprises retention means (112a) for retaining said connection element (134) in said groove (112G).

10. The tension arrangement according to claim 2, wherein said bracket member (110) has an elongated configuration configured to extend along a portion of said first side (I), when said tension arrangement (100) is attached in connection to said first side (I), having a first end portion (110a), an opposite second end portion (110b) and an intermediate portion (110c), wherein said at least one groove (112G) is arranged at said intermediate portion.

11. The tension arrangement according to claim 10, further comprising a guiding roller (140) configured to be arranged in connection to an end portion of said bracket member (110) so that its axis (X) extends transversal to the longitudinal extension of the bracket member (110), said first elongated transmission member (40), when said tension arrangement (100) is attached in connection to said first side (I) and the first elongated transmission member (40) is connected to the connection member (120), is configured to run from said connection member towards said end portion and turn, wherein said guiding roller (140) is configured to guide said first elongated transmission member (40) so that it turns around in connection to said guiding roller (140), extending in the opposite direction along said first side (I) to the other connection position.

12. The tension arrangement (100) according to claim 1, wherein said connection member (120) has an elongated configuration configured to extend along the longitudinal extension of said bracket member (110).

13. The tension arrangement (100) according to claim 2, wherein said bracket member (110) has a U-shaped configuration comprising a bottom portion (114) configured to constitute the attachment side, and a first side portion (116) and opposite second side portion (118) essentially parallel to said first side portion (116), said side portions extending in the longitudinal direction of said bracket member (110).

14. The tension arrangement according to claim 13, wherein said at least one groove (112G) is provided as one or more recesses in the respective side portion (116, 118) of said bracket member (110).

15. The tension arrangement according to claim 1, wherein said tension arrangement (100) is configured to be attached in connection to said first side (I) at said lower position.

16. A door operator system (S), the door operator system (S) being configured for opening and closing an opening (O), the door operator system comprising:
a door frame (10) comprising a first frame section (12) at a first side (I) of the opening (O) and a second frame section (14) at a second side (II) of the opening (O) opposite the first side (I);
a door (20) arranged to be moved between an open position and a closed position, the door (20) being movably arranged in connection to the door frame (10);
a drive arrangement (D), said drive arrangement comprising a drive unit (30) mounted on the door (20), said drive unit (30) comprising at least one motor (32) being arranged to move the door (20) between the open position and closed position and a first driven transmission member (34) in driving connection with the motor (32), the door operator system comprising
a first elongated transmission member (40) extending along the first side (I) of the opening (O) between an upper position and a lower position, the first elongated transmission member (40) being configured to be connected at said upper position and at said lower position, wherein the first driven transmission member (34) is movably connected to said first elongated transmission member (40) and arranged to interplay with said first elongated transmission member (40) for driving the first driven transmission member (34) along said first elongated transmission member (40) by means of the first elongated transmission member (40) so as to move the door (20) between the closed and open position, said door operator system comprising
a tension arrangement (100) configured to be attached in connection to said first side (I) at one of said upper and lower positions, said tension arrangement comprising
a bracket member for facilitating attachment of said tension arrangement;
a tension device comprising a connection member for connecting said first elongated transmission member and a spring arrangement comprising
a spring member, said spring arrangement being configured to be connected to said connection member so as to facilitate adapting the spring load of said spring member,
wherein said tension device is configured to be arranged in connection to said bracket member so that, when said first elongated transmission member is connected at one of said upper and lower positions and connected to said connection member at the other of said upper and lower positions, tension of said first elongated transmission member is provided.

17. A door operator system according to claim 16, wherein said drive arrangement (D) comprises a second driven transmission member (34) in driving connection with a motor (32) of said drive arrangement (D), the door operator system comprising a second elongated transmission member (40) extending along the second side (II) of the opening (O) between an upper position and a lower position, the second elongated transmission member (40) being configured to be connected at said upper position and at said lower position, wherein the second driven transmission member (34) is movably connected to said second elongated transmission member (40) and arranged to interplay with said second elongated transmission member (40) for driving the second driven transmission member (34) along said second elongated transmission member (40) by means of the second elongated transmission member (40) so as to move the door (20) between the closed and open position, said door operator system comprising a second tension arrangement (100) attached in connection to said second side for providing tension of said second elongated transmission member (40).
